(19) United States
(12) Patent Application Publication
(10) Pub. No.: US 2025/0208448 A1
(43) Pub. Date: Jun. 26, 2025

(54) Optical Waveguide Device, Optical Modulation Device and Optical Transmission Apparatus Using Same, and Method for Manufacturing Optical Waveguide Device

(71) Applicant: SUMITOMO OSAKA CEMENT CO., LTD., Tokyo (JP)

(72) Inventors: Katsutoshi KONDO, Tokyo (JP); Shotaro HIRATA, Tokyo (JP)

(73) Assignee: SUMITOMO OSAKA CEMENT CO., LTD., Tokyo (JP)

(21) Appl. No.: 18/968,442

(22) Filed: Dec. 4, 2024

(30) Foreign Application Priority Data
Dec. 22, 2023 (JP) 2023-216412

(51) Int. Cl. G02F 1/035

(52) U.S. Cl. CPC G02F 1/035; G02F 2202/20

(57) ABSTRACT

An optical waveguide device includes a low refractive index substrate 1 that includes a material having a lower refractive index than lithium niobate (LN), in which a thin film 2 including LN and having a thickness of 1 μm or lower is disposed on a part of the low refractive index substrate 1, an optical waveguide 10 having a higher refractive index than the substrate 1 and including a material other than LN is disposed on the substrate 1, at least a part of the optical waveguide 10 is continuously disposed from the substrate 1 to the thin film 2, and in a region (transition region) where the optical waveguide 10 crosses an outer peripheral portion of the thin film 2, a thickness of the thin film 2 forms a slope shape and a gradient (tanθ) of an edge is set to be 0.189 or lower.

### CROSS-REFERENCE TO RELATED APPLICATIONS

This application claims the benefit of Japanese Patent Application No. 2023-216412 filed Dec. 22, 2023, the disclosure of which is herein incorporated by reference in its entirety.

### BACKGROUND OF THE INVENTION

### Field of the Invention

The present invention relates to an optical waveguide device, an optical modulation device and an optical transmission apparatus using the same, and a method for manufacturing the optical waveguide device, and particularly relates to an optical waveguide device where an optical waveguide formed using a thin film of lithium niobate and an optical waveguide including a material other than lithium niobate are combined, an optical modulation device and an optical transmission apparatus using the same, and a method for manufacturing the optical waveguide device.

### Description of Related Art

In recent years, a Si waveguide has been used for optical communication waveguides (see Yikai Su, etc., “Silicon Photonic Platform for Passive Waveguide Devices: Materials, Fabrication, and Applications”, Advanced Materials Technologies. 1901153 (2020)). Since the Si waveguide uses a CMOS process, the Si waveguide has excellent scalability and cost reduction and enables optical reception where a light-receiving element (PD) including Ge/Si is provided.

Meanwhile, as disadvantages, the Si waveguide cannot be used in a visible light range, and it is difficult to perform a pure phase modulation control, for example, by causing a current to flow the Si waveguide for the phase modulation.

Thus, a novel platform in which silicon nitride (SiN) or a thin film of lithium niobate (thin film LiNbO₃ (TFLN)) is used as an optical waveguide core has been considered as an alternative technique (see Abdul Rahim, etc., “Expanding the Silicon Photonics Portfolio With Silicon Nitride Photonic Integrated Circuits”, Journal of Lightwave Technology, Vol. 35, No. 4, pp 639 (Feb. 15, 2017) and Mian Zhang, etc., “Integrated Lithium Niobate Electro-optic Modulators: When performance meets scalability”, Optica, Vol. 8, No. 5, pp 652 (2021)). A light source, phase modulation, reception, optical combining and branching (power combining and branching, wavelength combining and separation, polarization combining and separation, and the like) are essential for integration of optical functions. Since optimal materials for these configurations are different from each other, methods of integrating different materials have been developed.

Among these, a device in which optical combining and branching and phase modulation are integrated by loading a silicon nitride (SiN) or amorphous silicon (a-Si) waveguide on TFLN has been developed (see Sean Nelan, etc., “Ultra-high Extinction Dual-output Thin-film Lithium Niobate Intensity Modulator”, arXiv: 2207.02608v1 (Jul. 6, 2022)). This method has weaker optical confinement of the optical waveguide than a monolithic TFLN modulator (see Abdul Rahim, etc., “Expanding the Silicon Photonics Portfolio with Silicon Nitride Photonic Integrated Circuits”, Journal of Lightwave Technology, Vol. 35, No. 4, pp 639 (Feb. 15, 2017)). Thus, a bending radius is large at several hundred of μm, and a drive voltage (Vπ) is also high.

Therefore, as illustrated in FIG. 1, a method of using a Si-based waveguide (SiN, a-Si, or crystalline silicon (c-Si)) as an optical combining and branching section and using a rib-type TFLN as a phase modulation section has been considered. In FIG. 1, a passive waveguide region A is formed using a Si-based waveguide (10A to 10C, 10C represents a ring resonator) on a low refractive index substrate 1 including a material having a lower refractive index than lithium niobate, for example, SiO₂. In addition, in the TFLN 2, an optical control member 200 including a rib-type optical waveguide or a control electrode is formed, and an active waveguide region C is provided.

The optical waveguide device where the TFLN 2 is loaded on the low refractive index substrate 1 is advantageous in that the yield can be ensured because LiNbO₃ (LN) that is a hard-to-work (dry etching is difficult) material is not processed. However, a transition region B that connects the passive waveguide region A using the Si-based waveguide and the active waveguide region C using the TFLN_to each other is necessarily formed between the regions.

FIGS. 2A and 2B are cross-sectional views of the transition region B, in which FIG. 2A is an example where the Si-based waveguide 10 is disposed above the low refractive index substrate 1 and FIG. 2B is an example where the Si-based waveguide 10 is disposed in the low refractive index substrate 1. In a portion indicated by a dotted line frame D, a change in refractive index of the optical waveguide is large for a light wave propagating the Si-based waveguide 10, which causes an increase in optical connection loss of the transition region B.

In Japanese Patent Application No. 2023-054914 (filing date: Mar. 30, 2023), the present inventors disclose an efficient and highly productive optical connection method of a silicon nitride waveguide and a rib-type waveguide formed in a TFLN. However, a wafer on which the silicon nitride waveguide is formed and a wafer on which the TFLN is formed are bonded to form one wafer, and thus it is difficult to say that sufficient productivity can be ensured. In addition, the accuracy for bonding the substrate including the passive optical waveguide and the TFLN is required. When a margin is given to the bonding accuracy, an excessive space is required, and the chip size cannot be reduced.

### SUMMARY OF THE INVENTION

An object of the present invention is to solve the above-described issues and to provide an optical waveguide device that uses one wafer where a low refractive index substrate having a lower refractive index than lithium niobate and a TFLN are bonded, the optical waveguide device having a structure in which an appropriate margin is ensured during bonding, optical connection loss between different waveguides is small, and a chip size can be reduced. Further, another object of the present invention is to provide an optical modulation device and an optical transmission apparatus using the optical waveguide device, and a method for manufacturing the optical waveguide device.

In order to achieve the object, an optical waveguide device according to the present invention, an optical modulation device and an optical transmission apparatus using the same, and a method for manufacturing the optical waveguide device have the following technical features.
(1) An optical waveguide device includes a low refractive index substrate that includes a material having a lower refractive index than lithium niobate, in which a thin film including lithium niobate and having a thickness of 1 μm or lower is disposed on a part of the low refractive index substrate, an optical waveguide having a higher refractive index than the low refractive index substrate and including a material other than lithium niobate is disposed on the low refractive index substrate, at least a part of the optical waveguide is continuously disposed from the low refractive index substrate to the thin film, and in a region where the optical waveguide crosses an outer peripheral portion of the thin film, a thickness of the thin film forms a slope shape and a gradient of an edge is set to be 0.189 or lower.
(2) An optical waveguide device includes a low refractive index substrate that includes a material having a lower refractive index than lithium niobate, in which a thin film including lithium niobate and having a thickness of 1 μm or lower is disposed on a part of the low refractive index substrate, an optical waveguide having a higher refractive index than the low refractive index substrate and including a material other than lithium niobate is disposed in the low refractive index substrate, at least a part of the optical waveguide is continuously disposed from a region of the low refractive index substrate where the thin film is not disposed to a region of the low refractive index substrate where the thin film is disposed, and in a region where the optical waveguide crosses an outer peripheral portion of the thin film, a thickness of the thin film forms a slope shape and a gradient of an edge is set to be 0.189 or lower.
(3) In the optical waveguide device according to (1) or (2), a rib-type optical waveguide may be formed on the thin film.
(4) In the optical waveguide device according to (1) or (2), the material forming the low refractive index substrate may contain SiO₂.
(5) In the optical waveguide device according to (1) or (2), the material forming the optical waveguide may be any one of a material containing SiN or Si.
(6) An optical modulation device includes the optical waveguide device according to (3) that is accommodated in a case; and an optical fiber through which a light wave is input to the optical waveguide device or output from the optical waveguide device.
(7) In the optical modulation device according to (6), the optical waveguide device may include a modulation electrode for modulating a light wave propagating in the optical waveguide device, and an electronic circuit that amplifies a modulation signal to be input to the modulation electrode may be provided inside the case.
(8) An optical transmission apparatus includes the optical modulation device according to (7), a light source that inputs a light wave to the optical modulation device, and an electronic circuit that outputs a modulation signal to the optical modulation device.
(9) In a method for manufacturing the optical waveguide device according to (1) or (2), when the slope shape of the thin film is formed, a mixed solution of an alkali solution and hydrogen peroxide water is used as an etchant.
(10) In the method for manufacturing the optical waveguide device according to (9), when the slope shape of the thin film is formed, a soluble mask and an insoluble mask are sequentially laminated on the thin film and used as a mask material.

A first aspect of the present invention relates to an optical waveguide device including a low refractive index substrate that includes a material having a lower refractive index than lithium niobate, in which a thin film including lithium niobate and having a thickness of 1 μm or lower is disposed on a part of the low refractive index substrate, an optical waveguide having a higher refractive index than the low refractive index substrate and including a material other than lithium niobate is disposed on the low refractive index substrate, at least a part of the optical waveguide is continuously disposed from the low refractive index substrate to the thin film, and in a region where the optical waveguide crosses an outer peripheral portion of the thin film, a thickness of the thin film forms a slope shape and a gradient of an edge is set to be 0.189 or lower.

In addition, a second aspect of the present invention relates to an optical waveguide device includes a low refractive index substrate that includes a material having a lower refractive index than lithium niobate, in which a thin film including lithium niobate and having a thickness of 1 μm or lower is disposed on a part of the low refractive index substrate, an optical waveguide having a higher refractive index than the low refractive index substrate and including a material other than lithium niobate is disposed in the low refractive index substrate, at least a part of the optical waveguide is continuously disposed from a region of the low refractive index substrate where the thin film is not disposed to a region of the low refractive index substrate where the thin film is disposed, and in a region where the optical waveguide crosses an outer peripheral portion of the thin film, a thickness of the thin film forms a slope shape and a gradient of an edge is set to be 0.189 or lower.

This way, in the outer peripheral portion (transition region) of the thin film of lithium niobate that is disposed on the low refractive index substrate, the thickness of the thin film forms a slope shape and the gradient of the edge is set to be 0.189 or lower. There it is possible to provide the optical waveguide device having a structure in which an appropriate margin is ensured when the low refractive index substrate and the TFLN is bonded, optical connection loss between different waveguides is small, and a chip size can be reduced. Furthermore, an optical modulation device and an optical transmission apparatus using the optical waveguide device can be provided.

Further, in the method for manufacturing the optical waveguide device, when a slope shape of the thin film of lithium niobate is formed, a mixed solution of an alkali solution and hydrogen peroxide water is used as an etchant, and a soluble mask and an insoluble mask are sequentially laminated on the thin film and used as a mask material. As a result, the slope shape can be easily obtained as designed.

### BRIEF DESCRIPTION OF THE DRAWINGS

FIG. 1 is a plan view illustrating an example of an optical waveguide device where a passive waveguide and an active waveguide are combined.

FIGS. 2A and 2B are cross-sectional views illustrating a transition region B of the optical waveguide device of FIG. 1, in which FIG. 2A illustrates an example where an optical waveguide 10 is disposed on a TFLN 2 and FIG. 2B illustrates an example where the optical waveguide 10 is disposed in the low refractive index substrate 1.

FIG. 3 is a cross-sectional view illustrating an example of the optical waveguide device according to the present invention where the optical waveguide 10 is disposed on the TFLN 2.

FIG. 4 is a cross-sectional view illustrating an example of the optical waveguide device according to the present invention where the optical waveguide 10 is disposed in the low refractive index substrate 1 and subsequently the TFLN 2 is bonded to the low refractive index substrate 1.

FIG. 5 is a diagram illustrating a part of a manufacturing process of the optical waveguide device illustrated in FIG. 3.

FIG. 6 is a diagram illustrating a part of the manufacturing process following FIG. 5.

FIGS. 7A to 7C are diagrams illustrating a method of controlling a shape of an edge portion of the TFLN, in which FIG. 7A illustrates a case where an etched surface is concave, FIG. 7B illustrates a case where an etched surface is convex, and FIG. 7C illustrates a case where an etched surface is linear.

FIG. 8 is a diagram illustrating a sample for evaluating a shape change of LN caused by etching.

FIG. 9 is a graph illustrating an etching shape using the sample of FIG. 8.

FIG. 10 is a graph illustrating a relationship between a gradient of a slope and a thickness of a soluble mask using the sample of FIG. 8.

FIG. 11 is a graph illustrating an etching shape using the sample of FIG. 8 and illustrating a shape when stirring is performed during etching.

FIGS. 12A and 12B illustrate a case where a gradient of a slope of an edge portion of the TFLN is fixed, in which FIG. 12A is a perspective view and FIG. 12B is a three-view drawing (top view, side view, front view).

FIG. 13 is a graph illustrating height data and a fitting curve when etching is performed using the method of FIG. 7B.

FIGS. 14A and 14B illustrate a case where a gradient of a slope of an edge portion of the TFLN has an exponential shape (an etched surface is convex), in which

FIG. 14A is a perspective view and FIG. 14B is a three-view drawing.

FIG. 15 is a graph illustrating results of calculating optical loss when the gradient of the slope is changed (the length of the slope portion (Slope_L) is changed) regarding the edge portions of the TFLNs having the shapes illustrated in FIGS. 12A, 12B, 14A, and 14B.

FIG. 16 is a diagram illustrating a manufacturing process of the optical waveguide device illustrated in FIG. 4.

FIGS. 17A and 17B illustrate an optical waveguide device where an optical waveguide is disposed in a low refractive index substrate and the TFLN is integrated on the low refractive index substrate, in which FIG. 17A is a perspective view and FIG. 17B is a three-view drawing.

FIG. 18 is a diagram illustrating an application example of the optical waveguide device of FIGS. 12A and 12B and illustrating a configuration where a shape of the optical waveguide loaded on the TFLN is continuously changed to further suppress optical loss.

FIG. 19 is a diagram illustrating an application example of the optical waveguide device of FIGS. 17A and 17B and illustrating is a part of a manufacturing process of forming a rib-type optical waveguide on the TFLN.

FIG. 20 is a diagram illustrating a part of the manufacturing process following FIG. 19.

FIG. 21 is a perspective view illustrating the optical waveguide device formed in the manufacturing process of FIGS. 19 and 20.

FIG. 22 is a diagram illustrating an example of an optical transmission apparatus according to the present invention.

### DETAILED DESCRIPTION OF THE INVENTION

Hereinafter, an optical waveguide device according to the present invention will be described in detail with reference to preferred examples.

As illustrated in FIG. 3, the optical waveguide device according to the present invention includes a low refractive index substrate 1 that includes a material having a lower refractive index than lithium niobate, in which a thin film (TFLN) 2 including lithium niobate and having a thickness of 1 μm or lower is disposed on a part of the low refractive index substrate 1, an optical waveguide 10 having a higher refractive index than the low refractive index substrate 1 and including a material other than lithium niobate is disposed on the low refractive index substrate 1, at least a part of the optical waveguide 10 is continuously disposed from the low refractive index substrate 1 to the thin film 2, and in a region (transition region) where the optical waveguide 10 crosses an outer peripheral portion of the thin film 2, a thickness of the thin film 2 forms a slope shape and a gradient (tanθ) of an edge is set to be 0.189 or lower.

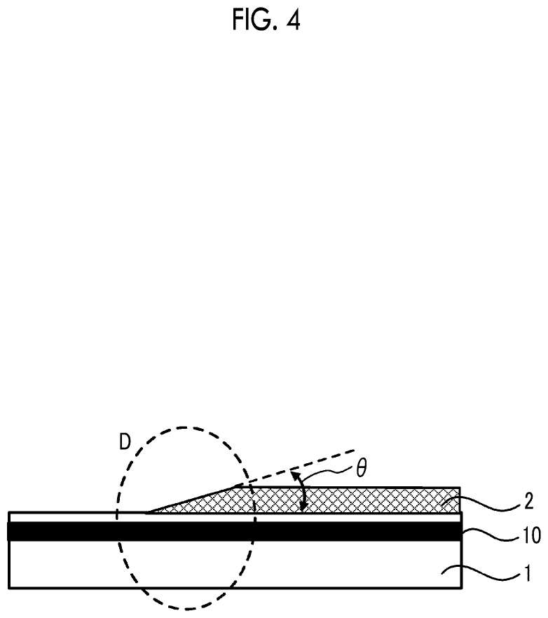

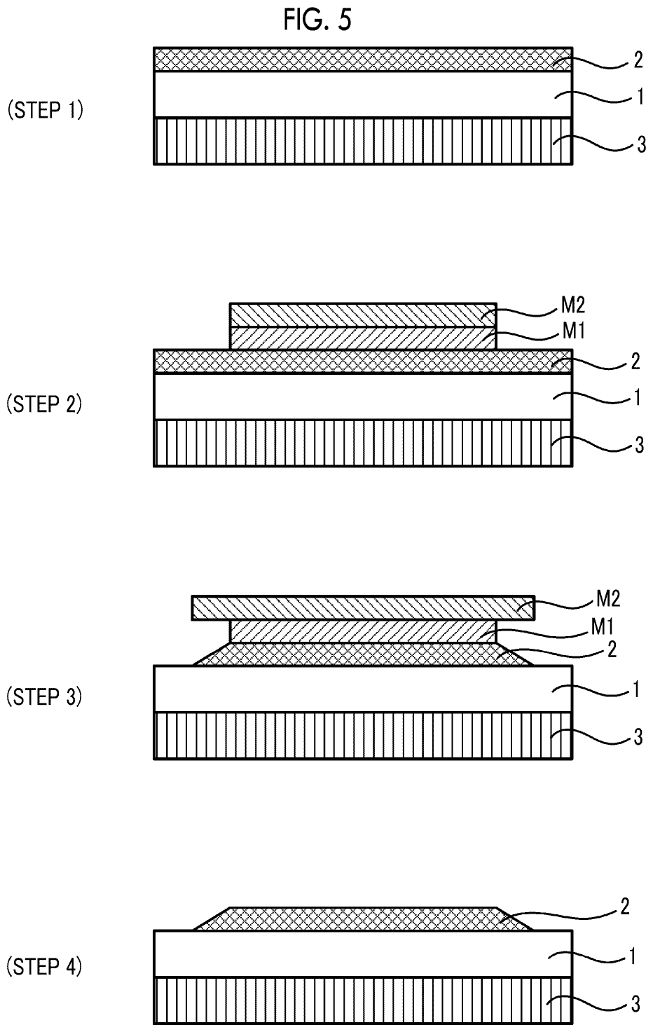

In addition, as illustrated in FIG. 4, the optical waveguide device according to the present invention includes a low refractive index substrate 1 that includes a material having a lower refractive index than lithium niobate, in which a thin film (TFLN) 2 including lithium niobate and having a thickness of 1 μm or lower is disposed on a part of the low refractive index substrate 1, an optical waveguide 10 having a higher refractive index than the low refractive index substrate 1 and including a material other than lithium niobate is disposed in the low refractive index substrate 1, at least a part of the optical waveguide 10 is continuously disposed from a region of the low refractive index substrate 1 where the thin film 2 is not disposed to a region of the low refractive index substrate 1 where the thin film 2 is disposed, and in a region (transition region) where the optical waveguide 10 crosses an outer peripheral portion of the thin film 2, a thickness of the thin film 2 forms a slope shape and a gradient (tanθ) of an edge is set to be 0.189 or lower.

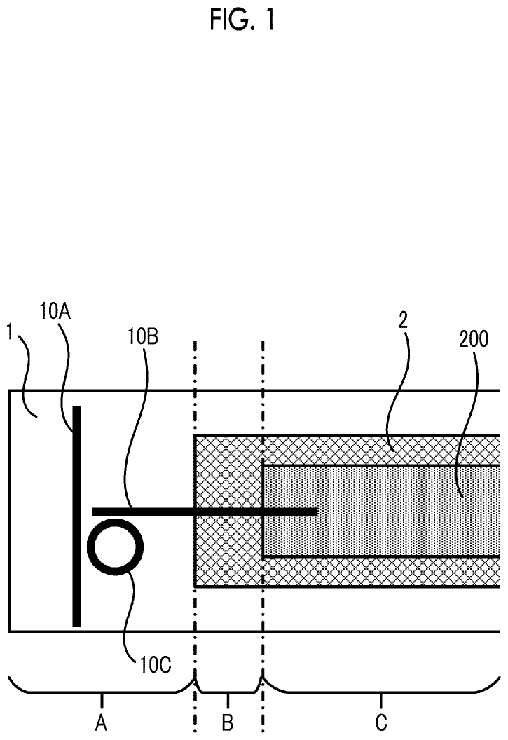

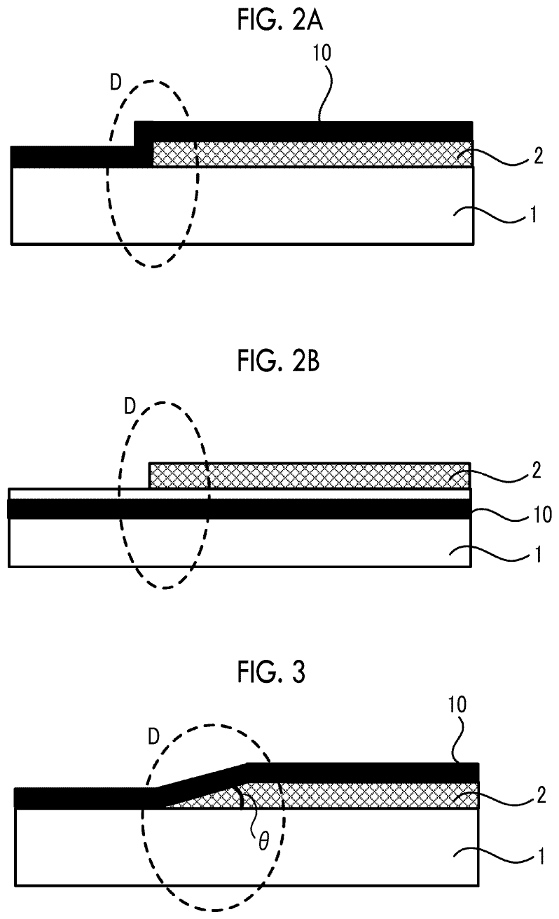

In the optical waveguide device according to the present invention, in the transition region B (the outer peripheral portion of the TFLN) that connects the passive waveguide region A and the active waveguide region C in FIG. 1, an inclined surface (slope shape) is formed on the TFLN 2. Specifically, the slope shape where the thickness of the TFLN 2 gradually changes is formed. The slope shape is not limited to a linear shape as illustrated in FIGS. 3 and 4, and a slope shape using a curved surface such as a shape that changes exponentially as described below can also be set. IN the optical waveguide device according to the present invention, by reducing an angle θ of an edge of the slope shape, specifically, by setting the gradient (tanθ) to be 0.189 or lower, optical connection loss in the transition region B can be suppressed.

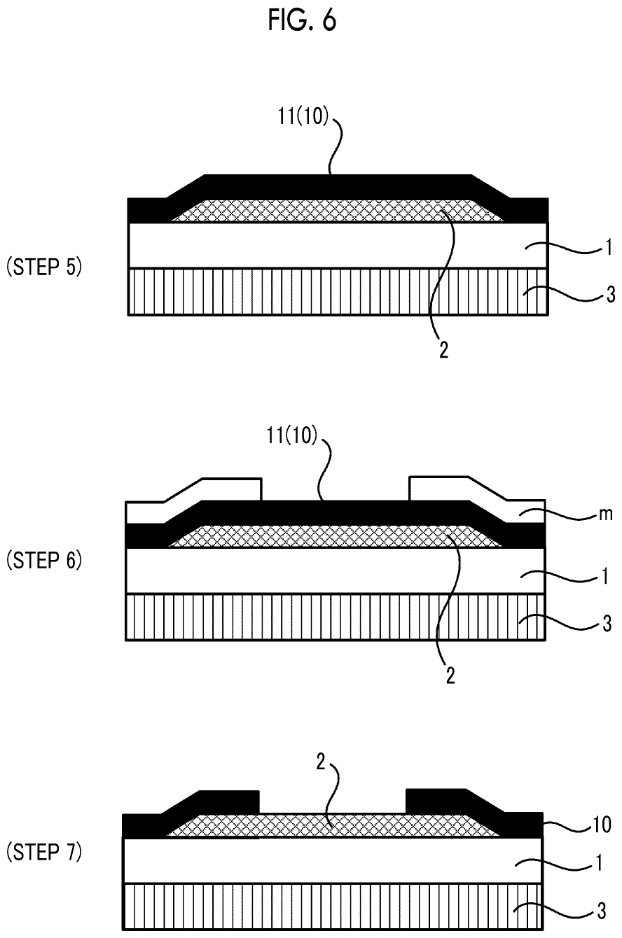

Next, a manufacturing process of the optical waveguide device illustrated in FIG. 3 will be described using FIGS. 5 and 6.

### Step 1

The TFLN 2 is directly bonded and joined to the low refractive index substrate 1 including a material such as SiO₂ to prepare a TFLN wafer. Reference numeral 3 represents a holding substrate that includes Si or SiO₂ to improve the mechanical strength of the entire TFLN wafer.

### Step 2

Films (etching mask) M1 and M2 including appropriate two layers are patterned on the TFLN 2. For example, a material of the first layer (layer in contact with the TFLN) is Ti or Al, and a material of the second layer is Au, Ni, or a-Si.

### Step 3

By using the patterned films (M1, M2) as an etching mask, the TFLN 2 is wet-etched. As the wet etchant, for example, a mixed solution (APM solution) of ammonia water and hydrogen peroxide water is appropriate. Here, an etching rate of the material of the first layer (M1) is faster than that of the material of the second layer or LN. Therefore, an etching shape of the TFLN has an inclined shape. When the low refractive index substrate 1 is SiO₂, SiO₂ is insoluble in the APM solution, and thus the low refractive index substrate 1 functions as an etching stop layer.

### Step 4

The mask material (M1, M2) is removed by an appropriate chemical or the like. For example, an iodine-potassium iodide aqueous solution can be used for Au, an APM solution can be used for Ti, and a KOH solution can be used for Al or a-Si.

### Step 5

A SiN film (11) for forming the optical waveguide 10 is formed on upper surfaces of the low refractive index substrate 1 and the TFLN 2. As a material of the optical waveguide 10, SiN, a-Si, or the like can be used. Hereinafter, SiN_will be mainly described.

### Step 6

By using an appropriate dry etching mask m, a SiN waveguide (10) is formed. At this time, the heights of the SiN waveguide in the passive waveguide region and the active waveguide region may be adjusted to be optimal in each of the regions, and this adjustment can be performed by performing dry etching multiple times.

### Step 7

After removing the dry etching mask m, cladding layer forming, a heat treatment, or electrode forming, or the like is performed as necessary. In FIG. 6, the optical waveguide (SiN waveguide) 10 is cut, for example. However, the optical waveguide 10 can also be formed in a continuous pattern.

Next, the wet etching of the TFLN will be described in detail.

In general, LN is chemically stable. Therefore, when LN is wet-etched, a chemical using hydrofluoric acid is used. This method has crystal orientation or crystal defect dependency, and the etching rate is also slow. Therefore, the method is not used for device manufacturing. In order to reduce the chemical stability of LN, a method of performing proton exchange or ion implantation for chemical etching using hydrofluoric acid or KOH is developed (see Di Zhu, etc. “Integrated photonics on thin-film lithium niobate”, Advances in Optics and Photonics Vol. 13, pp 242-352 (2021)). When hydrofluoric acid or high-concentration (about 50 wt %) KOH is used for wet-etching LN, there is a new issue in that SiO₂ of the low refractive index substrate 1 is also simultaneously etched. In addition, the slope shape of the TFLN edge depends on a distribution of proton exchange or ion implantation, and it is difficult to form the slope in any shape.

In order to solve this issue, the present inventors investigated etching rates of LN in many chemicals. As a result, it is found that LN can be etched by using a mixed solution of an alkali solution and hydrogen peroxide water. In addition, it is also found that SiO₂ is not etched by adopting ammonia water as the alkali solution.

The etching rate of LN in an X-axis direction is about 55 nm/hour for a solution where 29 wt % of ammonia water and 30 wt % of hydrogen peroxide water are mixed at a volume ratio of 1:3 at 40° C. The mixed solution of ammonia water and hydrogen peroxide water is known as a chemical, such as APM (Ammonia-hydrogen Peroxide mixture cleaning) or SC-1, used for cleaning a semiconductor, and it is known that LN can be etched with this mixed solution. Here, some of those skilled in the art may think that the etching rate of LN is slow. However, since the film thickness of the TFLN is 1 μm or lower and a batch process can be performed, this mixed solution can be used for device manufacturing.

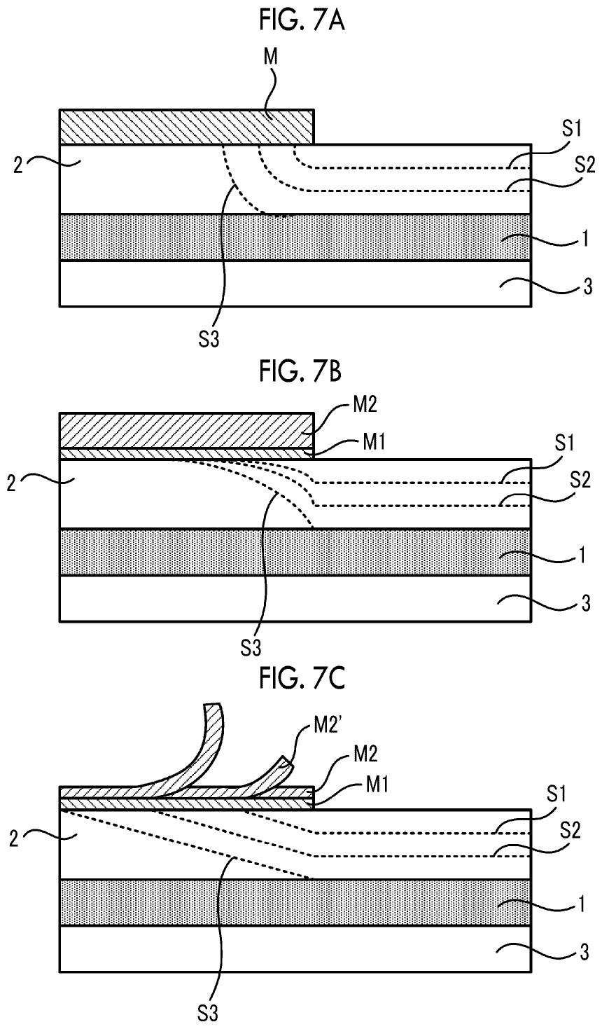

Next, a method of forming the TFLN edge portion in a slope shape using the above-described chemical will be described with reference to FIGS. 7A to 7C. Dotted lines indicated by S1 to S3 in each of the drawings represent the shapes of etched surfaces formed as etching progresses. FIG. 7A illustrates a case where an etching mask M is not soluble in a chemical (insoluble mask).

In this case, the TFLN 2 that is wet-etched has a shape that is roundly cut out (a shape that is concave with respect to the etched surface).

Next, in FIG. 7B, the etching mask includes two layers (M1, M2), and the mask M1 of the first layer includes “soluble mask” that is soluble in a chemical. In addition, when the mask M2 of the second layer is “insoluble and high-rigidity mask” that is insoluble and has high rigidity, in the chemical, LN is etched from an opening portion of the etching mask, and the etching mask M1 of the first layer is dissolved from the side. When the etching rate of the soluble mask M1 of the first layer is faster than the etching rate of LN, the dissolution of the first layer from the side slows down over time. Therefore, the edge shape of the TFLN is convex with respect to the etched surface. On the other hand, when the etching rate of the soluble mask of the first layer is slower than the etching rate of LN, the edge shape of the TFLN is concave with respect to the etched surface.

As illustrated in FIG. 7C, when the mask M2 of the second layer is “insoluble and low-rigidity mask” that is insoluble and has low rigidity, The etching mask M2 of the second layer (M2′ represents the mask in a floating state) floats due to the dissolution of the etching mask M1 of the first layer. As a result, the dissolution of the first layer M1 from the side is substantially fixed regarding the time, and the edge shape of the TFLN is linear.

By changing the thickness of the etching mask M1 of the first layer, the edge shape of the TFLN can also be changed. In addition, as described below using FIG. 11, when the insoluble and low-rigidity mask M2 of FIG. 7C does not float, the mask can be made float by stirring the chemical or by using a stress imparting film (for example, cure shrinkage of a photoresist).

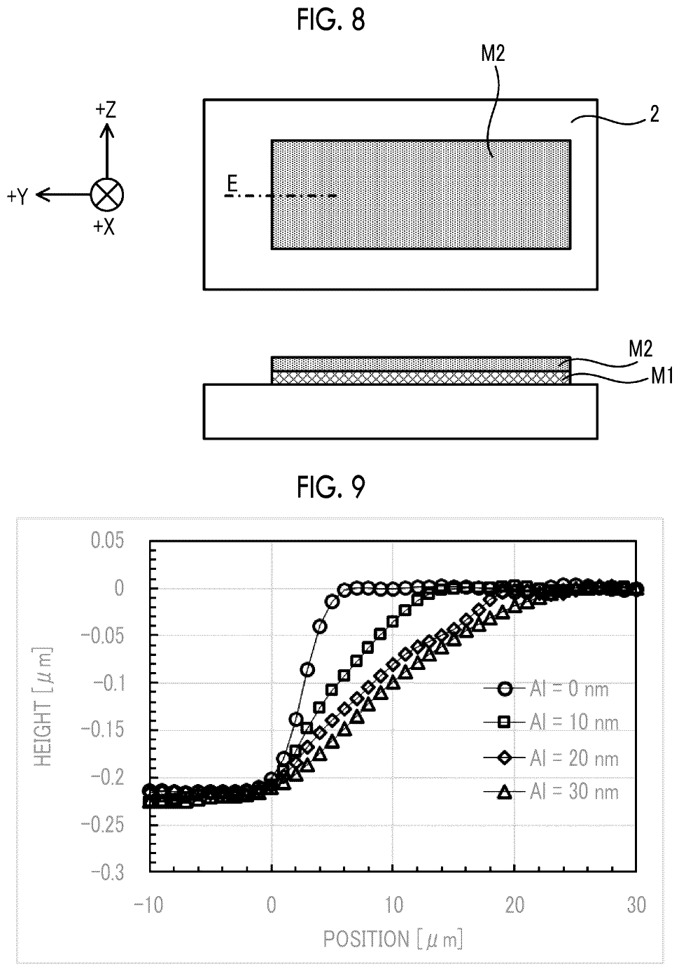

Further, it is found that the etching shape changes using the APM solution and the etching mask. Specifically, a sample illustrated in FIG. 8 was prepared to verify that the gradient of the slope changes depending on etching conditions. In FIG. 8, the etching mask M1 (soluble mask) and the etching mask M2 (insoluble mask) are laminated on the TFLN 2. In FIG. 8, the upper side is a plan view, and the lower side is a side view. The arrow on the left side of the plan view represents the crystal orientation, and it is understood that FIG. 8 illustrates LN of X-cut. A pattern is formed by using Al as the etching mask M1 and using a-Si as the etching mask M2. An RF sputtering device is used when Al and a-Si are laminated using a photography technique for forming the pattern. The thicknesses of Al are four kinds of 0, 10, 20, and 30 nm, and the thickness of a-Si is 100 nm.

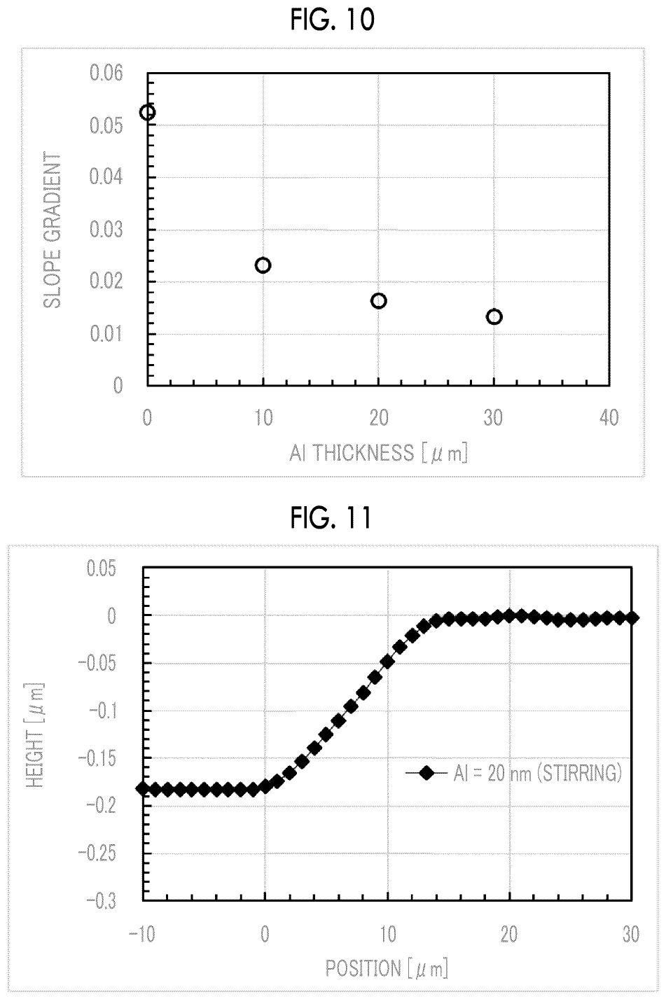

The X-cut LN with the etching masks of FIG. 8 is dipped in APM at 40° C. (mixed solution of 29 wt % of ammonia water and 30 wt % of hydrogen peroxide water (volume ratio=1:3) for 8 hours. Next, the etching mask is removed in an alkaline 1 N KOH solution, and the surface profile of LN is acquired using a contact type thickness meter. FIG. 9 illustrates a shape change of the etched surface when the thickness of the etching mask M1 (Al is used) is changed. In addition, FIG. 10 illustrates a relationship between the gradient of the etched surface (slope) of FIG. 9 and the thickness of the etching mask M1. As a result, it is found that, as the thickness of the soluble mask (M1) increases, the slope length (Slope_L) increases and the gradient of the slope decreases.

Further, when LN in the sample where the thickness of Al is 20 nm is etched in APM using the same method, a result of performing stirring is illustrated in FIG. 11. When stirring is performed, the shape of the slope portion is formed in a flat shape (linear shape).

By changing the material of the soluble mask M1 from Al to Ti or W having a high etching rate, the gradient of the slope can be further reduced. The gradient or shape of the slope has a trade-off relationship with the dimension of the optical transition region and optical loss, and is selected by design.

In addition, in the present example, X-cut LN is used. However, even with Z-cut LN, the same effect is verified.

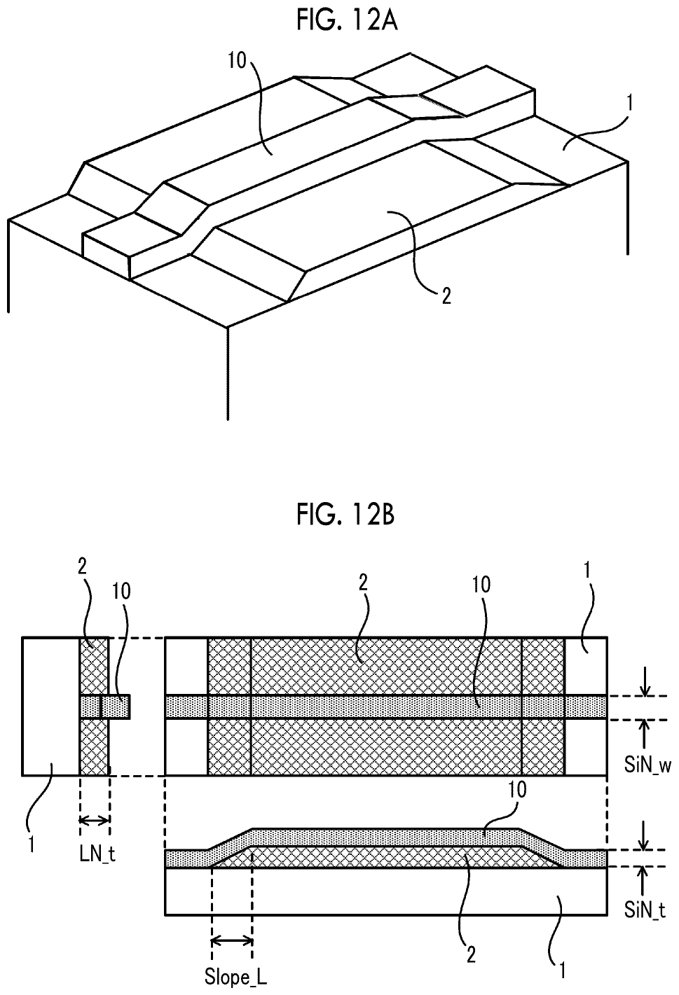

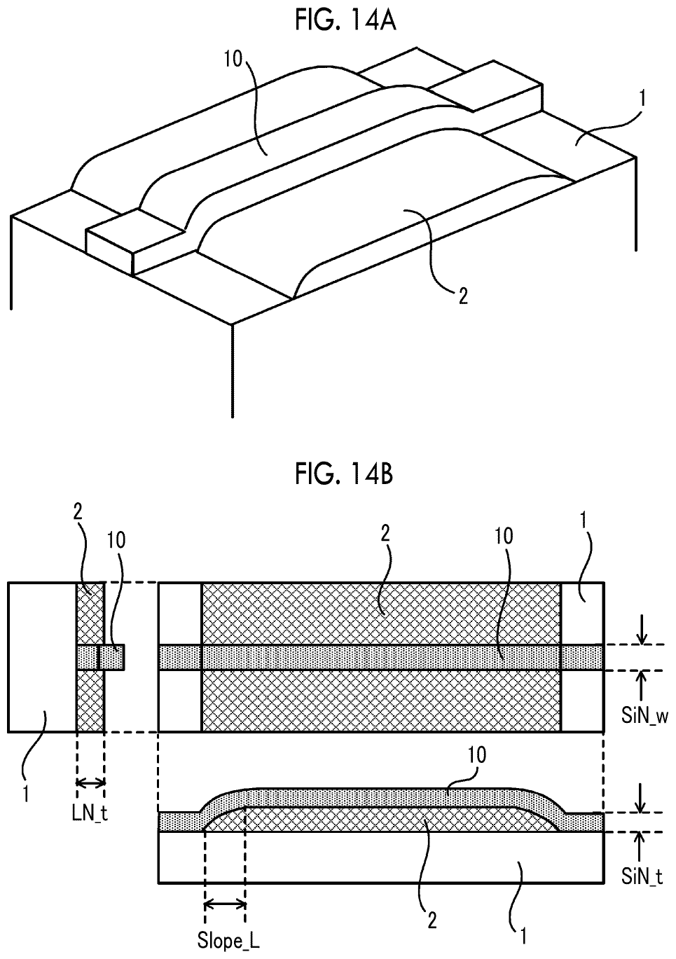

Next, when the optical waveguide (SiN waveguide) 10 is disposed in a range from the low refractive index substrate 1 to the TFLN 2, in order to verify conditions for optical transition with low loss, a simulation of optical connection loss is performed using models of FIGS. 12A, 12B, 14A, and 14B.

In the model of FIGS. 12A and 12B, the edge portion of the TFLN 2 (outer peripheral portion) is a flat slope (the thickness of the TFLN changes linearly). In the model of FIGS. 14A and 14B, the edge portion of the TFLN 2 is a convex curved slope (the thickness of the TFLN changes exponentially).

Each of FIGS. 12A and 14A is a perspective view, and each of FIGS. 12B and 14B is a three-view drawing in which the center is a plan view, the left side is a front view, and the lower side is a side view.

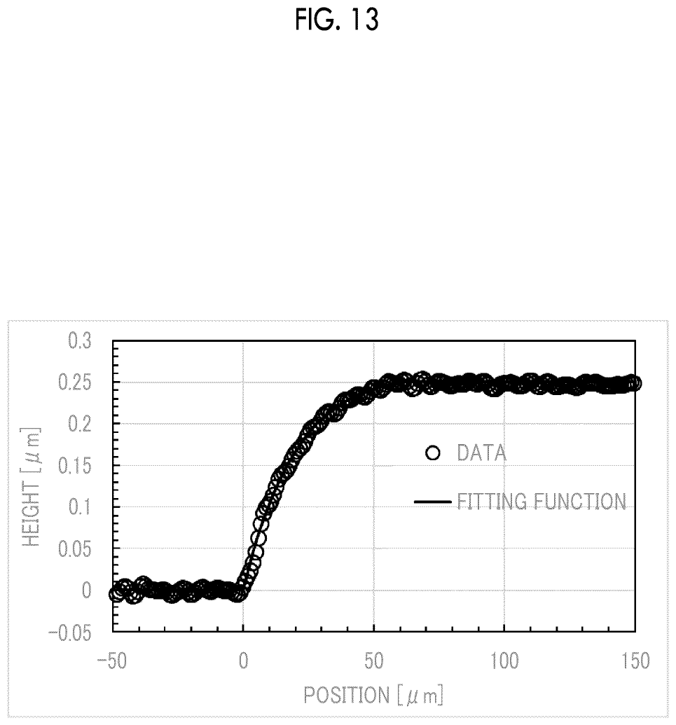

FIG. 13 illustrates actually measured data of the sample where the convex slope is formed by etching of the TFLN and results of fitting the surface shape of the data using an exponential function. When the exponential function represented by the following expression is used, fitting parameters are α=3, Slope_L=60 μm, and LN_t=0.25 μm.

$$y = \frac{LN\_t}{1 - {e}^{- α}} ( 1 - {e}^{- α X / Slope \_ L} )$$

In the model of FIGS. 14A and 14B, the shape of the convex curved slope is set using the exponential function (the above-described expression) used for the shape of FIG. 13.

By setting the width (SiN_w) of the optical waveguide (SiN waveguide) 10=0.8 μm, the thickness (SiN_t) of the optical waveguide 10=0.5 μm, and the thickness (LN_t) of the TFLN 2=0.3 μm as parameters of FIGS. 12A, 12B, 14A, and 14B and setting the length (Slope_L) of the slope portion as a variable, the optical loss of a light wave propagating in the optical waveguide 10 is simulated.

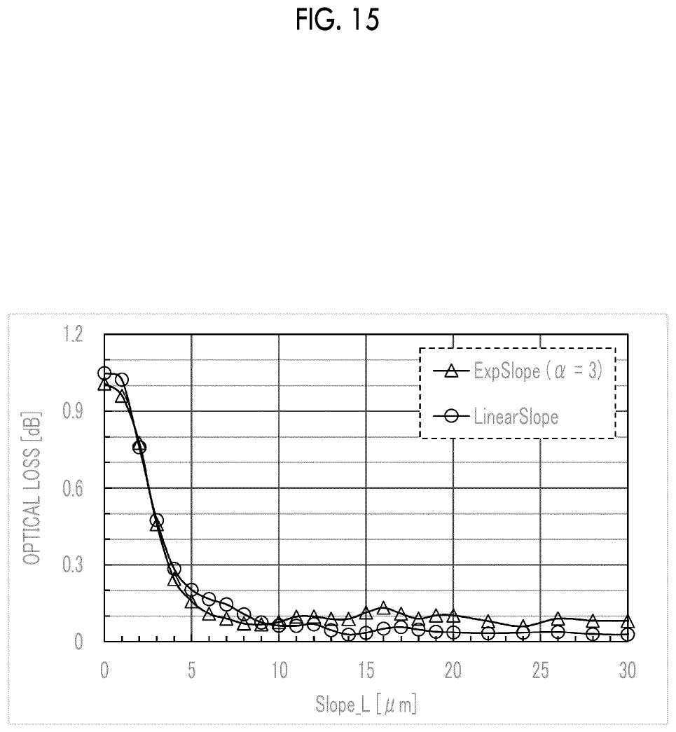

Specifically, by changing the length (Slope_L) of the slope portion of the TFLN in a range of 0 to 30 μm, an intensity ratio of output light to input light in the optical waveguide 10 (optical loss [dB]=−10·log 10 (output light/input light)) is derived. The simulation result is illustrated in FIG. 15.

Due to a difference between the slope shapes of FIGS. 12A, 12B, 14A, and 14B, there is a certain amount of difference in optical loss. As Slope_L increases, the optical loss approaches 0. In FIG. 15, when Slope_L is 5 μm or higher, the optical loss in the transition region can be ignored, and the maximum gradient of the exponential function at this time is 0.189 (to) 10°. The same result can be obtained even when LN_t, SiN_w, and SiN_t change. Based on this result, it is preferable that the change in the thickness of the thin film in the edge portion (outer peripheral portion) of the TFLN 2 (the gradient (tanθ) of the edge of the slope shape) is set to be 0.189 or lower.

In addition, in FIG. 15, when Slope_L is 5 μm or higher at LN_t of 0.3 μm, the optical loss is significantly reduced. Therefore, it can be said that, by setting LN_t (the thickness)/Slope_L (the length of the slope)≤0.06 as “average inclination” of the slope portion, an optical waveguide device with lower loss can be obtained.

Hereinabove, the example where the TFLN 2 is formed on a thermally oxidized Si substrate or a SiO₂ substrate that is the low refractive index substrate 1 and the optical waveguide (SiN waveguide) is formed on the upper surfaces of the low refractive index substrate 1 and the TFLN 2 is described.

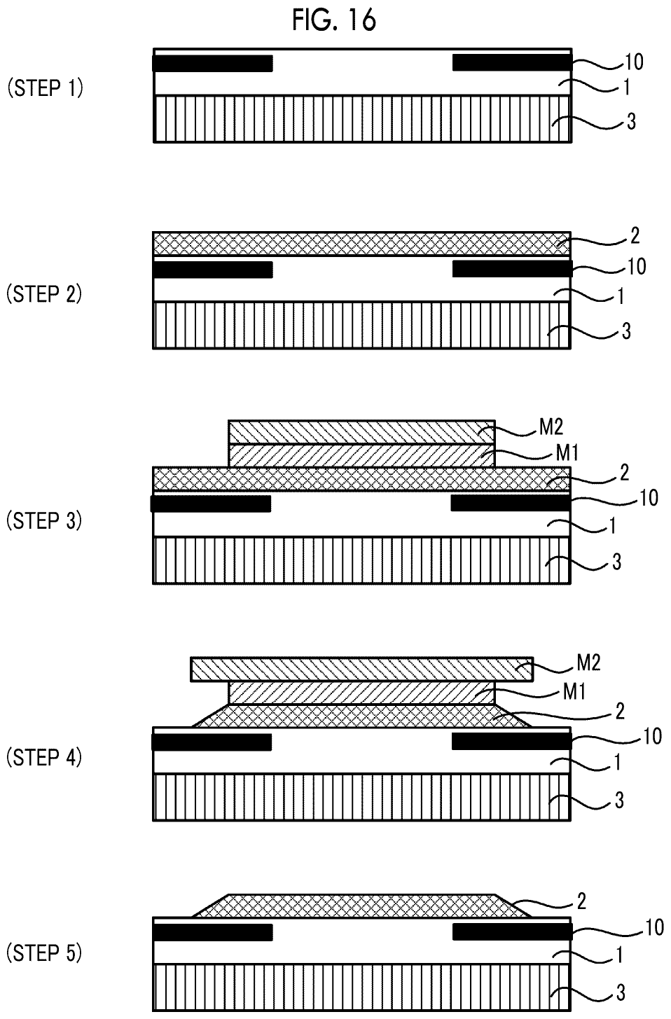

FIG. 16 is a diagram illustrating a method of integrating the TFLN 2 with the slope into the substrate 1 with the optical waveguide where the optical waveguide 10 is formed in the low refractive index substrate 1 as illustrated in FIG. 4.

### Step 1

The optical waveguide 10 is formed using SiN, amorphous Si, crystalline Si, or the like in the low refractive index substrate 1 including a material such as SiO₂, and the low refractive index substrate 1 where the upper surface (upper cladding) of the low refractive index substrate 1 is flattened is prepared. Reference numeral 3 represents a holding substrate.

### Step 2

The TFLN 2 is directly bonded and joined to the low refractive index substrate 1. When the TFLN 2 is joined, a three-layer structure where an intermediate layer (a material such as Ti or WOx (oxygen-deficient tungsten oxide) that is easy to remove is appropriate) is interposed on the Si substrate and the TFLN is disposed on the uppermost surface is used. For the joining of the low refractive index substrate 1 and the TFLN 2, plasma activation bonding is used. When the Si substrate is removed from the TFLN 2, a 5% TMAH solution is used, and when the intermediate layer is removed, the APM solution is used. In the above-described material configuration, the TMAH solution can remove only the Si substrate. Likewise, the etching rate of Ti or WOx in the APM solution is sufficiently faster than the etching rates of LN, Si, SiO₂, and SiN, and thus the influence on the remaining materials (LN, Si, SiO₂, and SiN) can be ignored.

### Step 3

Masks of two layers are formed at necessary positions. In the present example, Al is used as the soluble mask M1, and a-Si is used as the insoluble mask M2.

### Step 4

Using the APM solution, the TFLN 2 that is not protected with the masks is etched.

### Step 5

Using an 1 N potassium hydroxide aqueous solution, the etching masks (M1, M2) are removed.

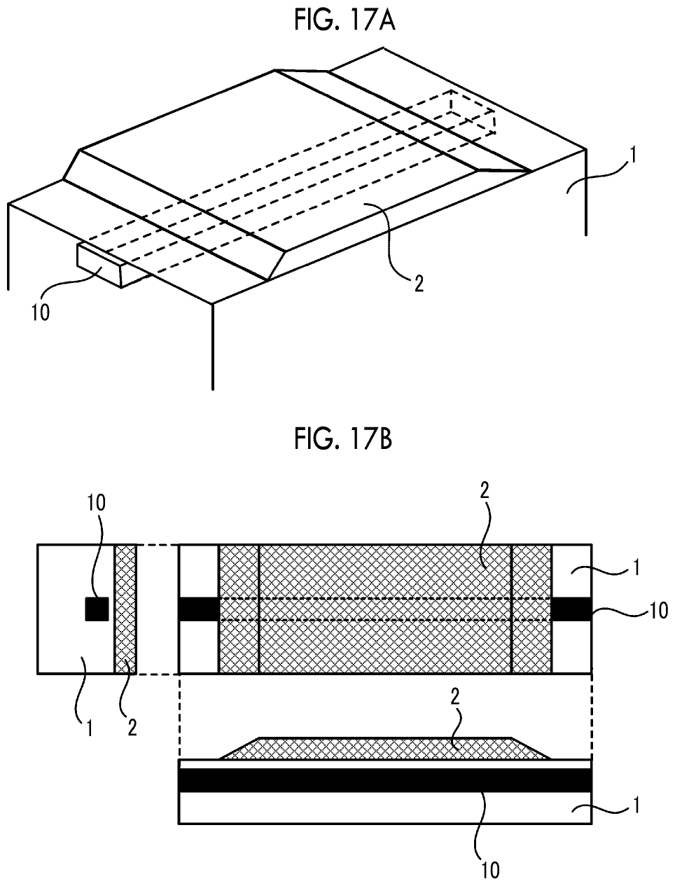

FIGS. 17A and 17B illustrate the optical waveguide device formed using the manufacturing method of FIG. 16. FIG. 17A is a perspective view of the optical waveguide device, and FIG. 17B is a three-view drawing of the optical waveguide device.

In FIGS. 17A and 17B, the optical waveguide 10 in the low refractive index substrate 1 is illustrated as one continuous optical waveguide. However, as illustrated in FIG. 16, a portion where the optical waveguide 10 is discontinuous may be present on the lower side of the TFLN 2 as necessary.

In FIGS. 3, 12A, 12B, 14A and 14B, when the optical waveguide 10 is formed on the upper side of the low refractive index substrate 1 and the TFLN 2, the optical waveguide 10 having the same thickness as that of the upper side of the TFLN 2 is also disposed on the upper side of the low refractive index substrate 1. In general, in an optical circuit including a channel waveguide, an optimal film thickness is present depending on the use.

On the other hand, when the channel waveguide having the same thickness as that on the low refractive index substrate 1 is formed on TFLN 2, the channel waveguide is likely to be a multimode waveguide. In addition, when an electrode is also taken into consideration to perform a light control, the efficiency (drive voltage) changes depending on the overlapping of an electric field profile formed by voltage application and a light distribution. Therefore, an optimal SiN film thickness or width varies between the passive waveguide region and the active waveguide region.

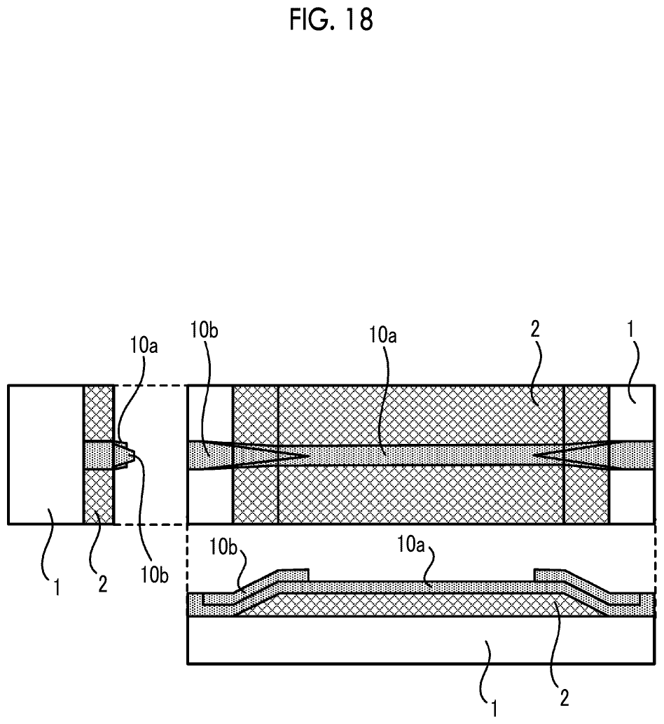

For example, when characteristic improvement has priority, as illustrated in FIG. 18, the SiN film thickness of the active waveguide region (on the TFLN 2) needs to be small. This configuration can support lithography and dry etching. In the transition region (the edge portion of the TFLN 2), by continuously changing the width of thickness of the SiN waveguide as illustrated in FIG. 18, the effective refractive index of the optical waveguide 10 can be continuously changed, and low-loss optical transition can be performed.

Likewise, even when the optical waveguide 10 is formed in the low refractive index substrate 1 as illustrated in FIGS. 4, 17A, and 17B, by changing the waveguide shape, an optical waveguide device with lower loss can be obtained irrespective of whether or not the TFLN 2 is loaded.

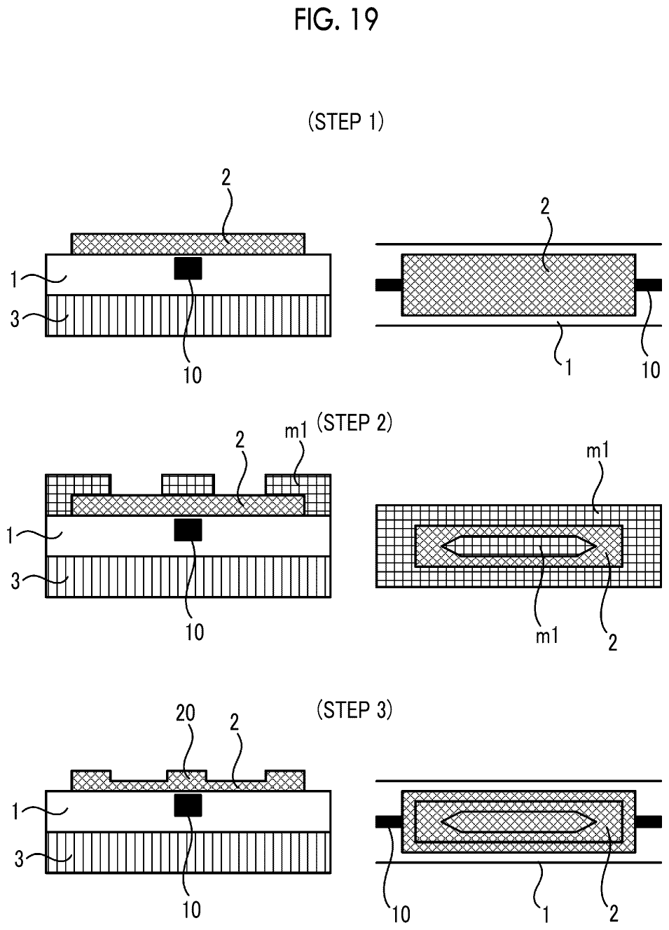

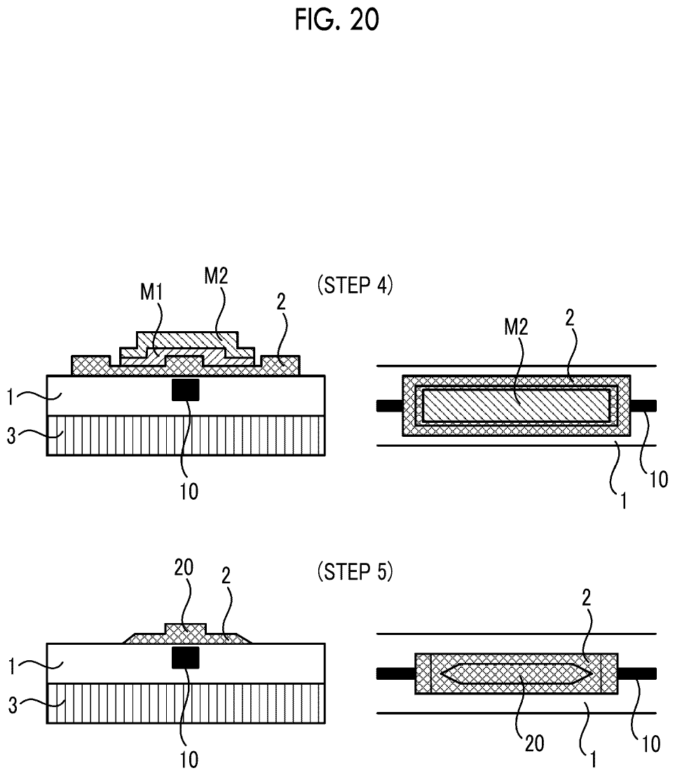

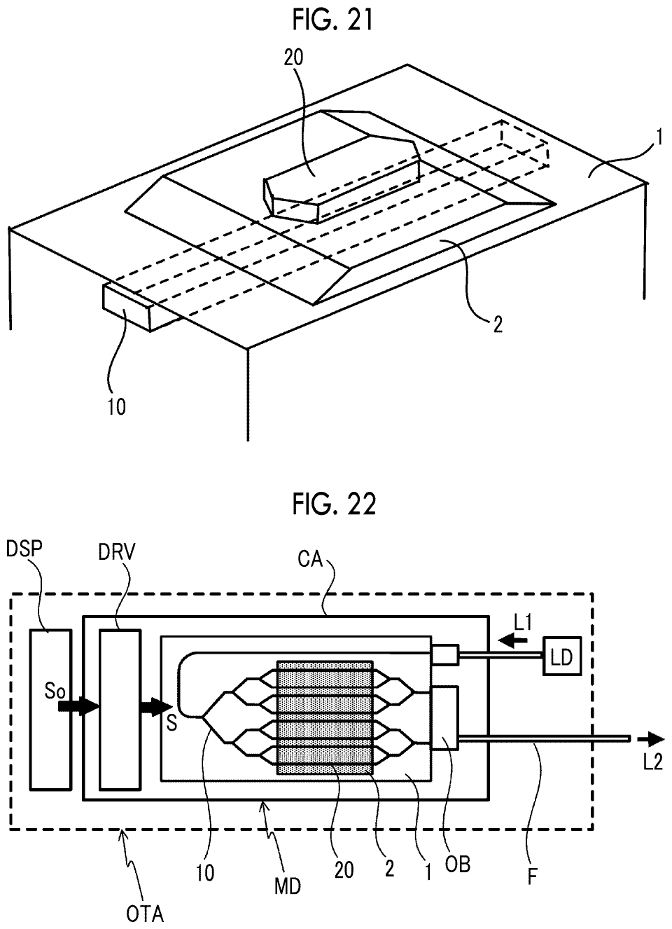

FIGS. 19 to 21 illustrate an optical waveguide device where a rib-type optical waveguide is formed on the upper surface of the TFLN 2. FIGS. 19 and 20 are diagrams illustrating a manufacturing process of the optical waveguide device, and FIG. 21 is a perspective view of the optical waveguide device. In each of steps of FIGS. 19 and 20, the left drawing is a cross-sectional view when seen from an extension direction of the optical waveguide 10, and the right drawing is a plan view of the optical waveguide device.

### Step 1

The TFLN 2 is bonded to the low refractive index substrate 1 including the optical waveguide 10. The size of the TFLN 2 is generally more than the size of the active waveguide region where the rib-type optical waveguide, the control electrode, or the like is formed.

### Step 2

A mask material ml for dry etching the TFLN 2 is formed. In general, an UV resist is used for UV exposure, and an EB resist is used for EB exposure.

### Step 3

The TFLN 2 is processed by dry etching, and the mask material is removed to form a rib-type optical waveguide 20 on the TFLN 2.

### Step 4

The vicinity of the rib-type optical waveguide of the TFLN 2 that is desired to remain is covered with a laminated film of the soluble mask M1 and the insoluble mask M2. For example, Al is used for the soluble mask M1, and a-Si is used for the insoluble mask M2.

### Step 5

Using the APM solution, the TFLN 2 is etched. At this time, SiO₂, Si, or SiN is not etched. After dissolving the unnecessary TFLN 2, Al and a-Si of the mask materials are removed by potassium hydroxide.

In the optical waveguide device including the rib-type optical waveguide disclosed in Japanese Patent Application No. 2023-054914 (filing date: Mar. 30, 2023), a protrusion portion is present in the edge portion of the TFLN, and the manufacturing process is also complicated. In the present invention, this protrusion portion is unnecessary, and low-loss optical transition can be performed only by forming a two-dimensional pattern.

In the description of the present invention, SiN and SiO₂ are used as the material of the passive waveguide region. However, the present invention is not limited to this material.

In addition, in the present invention, a configuration in which a cladding material having a low refractive index is deposited on the upper surface of the passive waveguide or the TFLN can also be adopted in combination.

The above-described holding substrate may include a single cladding material or may include a plurality of cladding materials.

Further, an electrode may be formed in the active waveguide region.

In addition, the shape of the edge portion of the TFLN 2 parallel to the optical waveguide 10 is not particularly limited. When X-cut LN is used, the Z-axis of the crystal is orthogonal to the waveguide. On the +Z plane and the -Z plane, the etching rates are different, and thus the edge of the TFLN is asymmetrical. In FIG. 20 (STEP 5), the etching shape of the edge portion of the TFLN 2 is bilaterally symmetrical but may be asymmetrical. The reason for this is that there is no optical influence as long as the edge portion of the TFLN is distant from the optical waveguide 10.

Since the refractive index (to 1.45) of the cladding (SiO₂) is low, the optical waveguide of the passive waveguide region can be rapidly bent, which is advantageous in miniaturization.

On the other hand, in the active waveguide region, LN having the electro-optic effect is present, and thus optical phase control can be performed.

In a boundary (transition region) between the passive waveguide region and the active waveguide region, the thickness of the TFLN continuously changes, and thus optical connection loss can be reduced. Of course, the optical waveguide of the active waveguide region is not limited to being linear.

Next, examples in which the optical waveguide device according to the present invention is applied to an optical modulation device and an optical transmission apparatus will be described. While an example of a high bandwidth-coherent driver modulator (HB-CDM) will be used in the following description, the present invention is not limited to the example and can also be applied to an optical phase modulator, an optical modulator having a polarization combining function, an optical waveguide device in which a larger or smaller number of Mach-Zehnder type optical waveguides are integrated, a device joined to an optical waveguide device including other materials such as silicon, a device used as a sensor, and the like.

As illustrated in FIG. 22, the optical waveguide device adopts the substrate where the TFLN 2 is bonded to the low refractive index substrate 1 and includes: the optical waveguide that includes the SiN waveguide 10 or the rib-type optical waveguide 20; and the control electrode (not illustrated) such as a modulation electrode that modulates a light wave propagating in the rib-type optical waveguide 20. The optical waveguide device is accommodated in a case CA. Furthermore, an optical modulation device MD can be configured by providing an optical fiber (F) through which a light wave is input to the optical waveguide and output from the optical waveguide.

In FIG. 22, the optical fiber F is optically coupled to the SiN waveguide 10 inside the optical waveguide device using an optical block including an optical lens, a lens barrel, a polarization-combining part OB, and the like. The present invention is not limited to this configuration. The optical fiber may be introduced into the case through a through-hole that penetrates a side wall of the case. The optical fiber may be directly joined to an optical component or to the substrate, or the optical fiber having a lens function in an end portion of the optical fiber may be optically coupled to the optical waveguide in the optical waveguide device. In addition, a reinforcing member (not illustrated) can be disposed to overlap along an end surface of the substrate (includes the low refractive index substrate 1) including the SiN waveguide in order to stably join the optical fiber or the optical block. In the polarization-combining part OB, a space system can be replaced with a waveguide by applying the waveguide structure described in Mian Zhang, etc., “Integrated Lithium Niobate Electro-optic Modulators: When performance meets scalability”, Optica, Vol. 8, No. 5, pp 652 (2021) to the SiN waveguide. Manufacturing and member costs can be suppressed.

An optical transmission apparatus OTA can be configured by connecting, to the optical modulation device MD, an electronic circuit (digital signal processor DSP) that outputs a modulation signal So causing the optical modulation device MD to perform a modulation operation. It is necessary to amplify the modulation signal So output from the digital signal processor DSP in order to obtain a modulation signal S to be applied to the optical waveguide device. For this necessity, in FIG. 22, a driver circuit DRV is used to amplify the modulation signal. The driver circuit DRV and the digital signal processor DSP can also be disposed outside the case CA or can also be disposed inside the case CA. Particularly, the driver circuit DRV can be disposed inside the case to further reduce propagation loss of the modulation signal from the driver circuit.

While input light L1 of the optical modulation device MD may be supplied from an outside of the optical transmission apparatus OTA, a semiconductor laser (LD) can also be used as a light source as illustrated in FIG. 22. Output light L2 modulated by the optical modulation device MD is output to the outside through the optical fiber F.

As described above, according to the present invention, it is possible to provide an optical waveguide device that uses one wafer where a low refractive index substrate having a lower refractive index than lithium niobate and a TFLN are bonded, the optical waveguide device having a structure in which an appropriate margin is ensured during bonding, optical connection loss between different waveguides is small, and a chip size can be reduced. Further, it is also possible to provide an optical modulation device and an optical transmission apparatus using the optical waveguide device, and a method for manufacturing the optical waveguide device.

What is claimed is:

1. An optical waveguide device comprising:
a low refractive index substrate that comprises a material having a lower refractive index than lithium niobate,
wherein a thin film comprising lithium niobate and having a thickness of 1 μm or lower is disposed on a part of the low refractive index substrate,
an optical waveguide having a higher refractive index than the low refractive index substrate and comprising a material other than lithium niobate is disposed on the low refractive index substrate,
at least a part of the optical waveguide is continuously disposed from the low refractive index substrate to the thin film, and
in a region where the optical waveguide crosses an outer peripheral portion of the thin film, a thickness of the thin film forms a slope shape and a gradient of an edge is set to be 0.189 or lower.

2. An optical waveguide device comprising:
a low refractive index substrate that comprises a material having a lower refractive index than lithium niobate,
wherein a thin film comprising lithium niobate and having a thickness of 1 μm or lower is disposed on a part of the low refractive index substrate,
an optical waveguide having a higher refractive index than the low refractive index substrate and comprising a material other than lithium niobate is disposed in the low refractive index substrate,
at least a part of the optical waveguide is continuously disposed from a region of the low refractive index substrate where the thin film is not disposed to a region of the low refractive index substrate where the thin film is disposed, and
in a region where the optical waveguide crosses an outer peripheral portion of the thin film, a thickness of the thin film forms a slope shape and a gradient of an edge is set to be 0.189 or lower.

3. The optical waveguide device according to claim 1, wherein a rib-type optical waveguide is formed on the thin film.

4. The optical waveguide device according to claim 1, wherein the material forming the low refractive index substrate contains SiO₂.

5. The optical waveguide device according to claim 1, wherein the material forming the optical waveguide is any one of a material containing SiN or Si.

6. An optical modulation device comprising:
the optical waveguide device according to claim 1 that is accommodated in a case; and
an optical fiber through which a light wave is input to the optical waveguide device or output from the optical waveguide device.

7. The optical modulation device according to claim 6,
wherein the optical waveguide device includes a modulation electrode for modulating a light wave propagating in the optical waveguide device, and
an electronic circuit that amplifies a modulation signal to be input to the modulation electrode is provided inside the case.

8. An optical transmission apparatus comprising:
the optical modulation device according to claim 7;
a light source that inputs a light wave to the optical modulation device; and
an electronic circuit that outputs a modulation signal to the optical modulation device.

9. A method for manufacturing the optical waveguide device according to claim 1,
wherein when the slope shape of the thin film is formed, a mixed solution of an alkali solution and hydrogen peroxide water is used as an etchant.

10. The method for manufacturing the optical waveguide device according to claim 9,
wherein when the slope shape of the thin film is formed, a soluble mask and an insoluble mask are sequentially laminated on the thin film and used as a mask material.

11. A method for manufacturing the optical waveguide device according to claim 2,
wherein when the slope shape of the thin film is formed, a mixed solution of an alkali solution and hydrogen peroxide water is used as an etchant.

12. The method for manufacturing the optical waveguide device according to claim 11,
wherein when the slope shape of the thin film is formed, a soluble mask and an insoluble mask are sequentially laminated on the thin film and used as a mask material.
